(19) United States
(12) Patent Application Publication
(10) Pub. No.: US 2024/0094449 A1
(43) Pub. Date: Mar. 21, 2024

(54) NONFERROUS MAGNETIC FILTER SYSTEM

(71) Applicant: SHENZHEN NEEWER TECHNOLOGY CO. LTD, Shenzhen (CN)

(72) Inventors: Jun WANG, Shenzhen (CN); Yan KE, Shenzhen (CN)

(73) Assignee: SHENZHEN NEEWER TECHNOLOGY CO. LTD, Shenzhen (CN)

(21) Appl. No.: 17/948,958

(22) Filed: Sep. 20, 2022

(51) Int. Cl. G02B 5/26; G02B 7/00; G03B 17/12

(52) U.S. Cl. CPC G02B 5/26; G02B 7/006; G03B 17/12

(57) ABSTRACT

Disclosed is a nonferrous magnetic filter system. The nonferrous magnetic filter system includes a filter assembly and an adapter ring. The filter assembly includes a lens ring, a first magnet, a first filter lens and a first clamping ring. The first magnet and the filter lens are firmly pressed and fixed on the lens ring through the first clamping ring. The adapter ring includes a fixing ring, a second magnet and a second clamping ring. The second magnet is firmly pressed and fixed on the fixing ring through the second clamping ring. The filter assembly is configured to be assembled on the adapter ring from a side of the adapter ring through a mutual adsorption of the first magnet and the second magnet.

### TECHNICAL FIELD

The present disclosure relates to the technical field of magnetic filter equipment, and in particular to a nonferrous magnetic filter system.

### BACKGROUND

In the photography, attaching a filter into a camera lens can filter out a part of light or eliminate the reflections from a surface of an object to create a special photography effect, reaching a best photography effect. Meanwhile, in order to reach different shooting purposes, changing different types of filter lenses according to different requirement is practicable.

The existing way of mounting a filter includes using a spring clamping, an adapter ring connection or a magnetic adsorption. As a relatively novel method for mounting the filter, the magnetic adsorption still remains many disadvantages. For example, in the existing magnetic filter mounting assembly, parts that attracts the magnet are made of ferrous material. However, the ferrous material is heavy in mass, the parts are easy to fall from the lens, overloading and offsetting the lens. Besides, the ferrous material is easy to get oxidized when exposed in the air, lowering a service life of the magnetic filter mounting assembly, and the oxidized ferrous material will make an appearance of the magnetic filter mounting assembly unsightly.

### SUMMARY

The present disclosure provides a nonferrous magnetic filter system, aiming to solve a defect in the related art. The magnetic filter system is a magnetic filter mounting assembly, and the assembly is made of nonferrous magnetic material, which effectively reduces the weight of the whole magnetic filter system, thus the magnetic filter system can maintain beauty and be more durable.

The present disclosure is realized by the following technical solutions.

The present disclosure provides a nonferrous magnetic filter system, including: a filter assembly including a lens ring, a first magnet, a first filter lens and a first clamping ring; and an adapter ring including a fixing ring, a second magnet and a second clamping ring, a first slot for containing a magnet is provided on an edge of the lens ring; the first magnet is mounted in the first slot; the first filter lens is mounted in a through hole of the lens ring; the first magnet and the filter lens are firmly pressed and fixed on the lens ring through the first clamping ring; a second slot for containing the magnet is provided on an edge of the fixing ring; the second magnet is mounted in the second slot; the second magnet is firmly pressed and fixed on the fixing ring through the second clamping ring; and the filter assembly is configured to be assembled on the adapter ring from a side of the adapter ring through a mutual adsorption of the first magnet and second magnet.

In an embodiment, a second filter lens is mounted in a through hole of the adapter ring; and both the second magnet and the second filter lens are firmly pressed and fixed on the fixing ring through the second clamping ring.

In an embodiment, a side of the fixing ring away from the filter assembly is provided with a first external thread structure screwed with a lens.

In an embodiment, the nonferrous magnetic filter system comprises at least two filter assemblies; and the at least two filter assemblies are adsorbed and successively assembled to each other by aligning the corresponding first magnet.

In an embodiment, the lens ring, the first clamping ring, the fixing ring and the second clamping ring are all made of nonmagnetic metal or alloy material.

In an embodiment, both the first magnet and the second magnet are annular magnetic stripes or columnar magnetic blocks; and the first slot and second slot are annular slots or have a plurality of annularly distributed slot holes.

In an embodiment, the nonferrous magnetic filter system further including: a lens cap including a fixing cover ring, a third magnet and a cover plate, an edge of the fixing cover ring is provided with a third slot for containing the magnet, the third magnet is mounted in the third slot, the cover plate is mounted on a side of the fixing cover ring; the lens cap is configured to be assembled on the filter assembly from a side away from the adapter ring through a mutual adsorption of the third magnet and the first magnet; or the lens cap is configured to be assembled on the adapter ring from a side of the adapter ring through a mutual adsorption of the third magnet and second magnet.

In an embodiment, a side of the fixing cover ring away from the cover plate is provided with a second external thread structure screwed with the lens.

In an embodiment, the fixing cover ring is made of nonmagnetic metal or alloy material.

In an embodiment, the third magnet is an annular magnet stripe or a columnar magnetic block; and the third slot is an annular slot or has a plurality of annularly distributed slot holes.

Compared with the related art, the present disclosure has the following advantages and beneficial effects.

Firstly, the magnetic filter system of the present disclosure is a magnetic filter mounting assembly, and the assembly is made of nonferrous magnetic material. The assembly between the filter assembly and the adapter ring is completely realized by the magnetic adsorption of the magnet. The lens ring, the first clamping ring, the fixing ring and the second clamping ring are made of nonmagnetic metal or alloy material, which effectively reduces the weight of the whole magnetic filter system and avoids the oxidizing defect of the ferromagnetic material, thus the magnetic filter system can maintain beauty and be more durable.

Secondly, in the magnetic filter system of the present disclosure, a plurality of filter assemblies are successively assembled according to an actual shooting purpose, or the adapter ring with the filter is assembled with a plurality of filter assemblies, and the filter assembly and the adapter ring with the filter can be pulled out to be replaced, thus meeting various kinds of shooting requirements.

Lastly, the magnetic filter system of the present disclosure further includes a lens cap, and the lens cap can be attached into a camera lens through a thread engagement so as to protect the camera lens, or the lens cap can also be assembled in the filter assembly or in a front end of the adapter ring, so as to directly protect the filter assembly or the adapter ring for a flexible usage.

### BRIEF DESCRIPTION OF THE DRAWINGS

FIG. 1a is a schematic assembly structural view of the filter assembly of the nonferrous magnetic filter system in the embodiment 1.

FIG. 1B is a schematic cross-section structural view of the filter assembly of the nonferrous magnetic filter system in the embodiment 1.

FIG. 2a is a schematic assembly structural view of the adapter ring of the nonferrous magnetic filter system in the embodiment 1.

FIG. 2b is a schematic cross-section structural view of the adapter ring of the nonferrous magnetic filter system in the embodiment 1.

FIG. 3a is a schematic structural view of the nonferrous magnetic filter system in the embodiment 1.

FIG. 3b is a schematic cross-section structural view of the nonferrous magnetic filter system in the embodiment 1.

FIG. 4a is a schematic assembly structural view of the adapter ring of the nonferrous magnetic filter system in the embodiment 2.

FIG. 4b is a schematic cross-section structural view of the adapter ring of the nonferrous magnetic filter system in the embodiment 2.

FIG. 5a is a schematic structural view of the nonferrous magnetic filter system in the embodiment 2.

FIG. 5b is a schematic cross-section structural view of the nonferrous magnetic filter system in the embodiment 2.

FIG. 6a is a schematic assembly structural view of the lens cap of the nonferrous magnetic filter system in the embodiment 3.

FIG. 6b is a schematic cross-section structural view of the lens cap of the nonferrous magnetic filter system in the embodiment 3.

### DETAILED DESCRIPTION OF THE EMBODIMENTS

The specific embodiments of the present disclosure will be further described with reference to the accompanying drawings, while the specific embodiments described herein are not intended to limit the present disclosure. In the description of the embodiments of the present disclosure, it should be noted that the terms “I”, “II”, “III”, “first”, “second”, etc. are only used for convenience and simplicity of description, and are not intended to indicate or imply that the devices or elements being referred to must be in a particular order, constructed or operated in a particular order, and therefore should not be understood as a limit to the present disclosure, nor should be understood as indicating or implying relative importance.

### Embodiment 1

The nonferrous magnetic filter system of the present disclosure includes a filter assembly 1 and an adapter ring 2, the filter assembly 1 is mounted in front of a camera lens through the adapter ring 2. Specifically, the adapter ring 2 is mounted on the front end of the camera lens, while the filter assembly 1 is assembled on the adapter ring 2 through magnetic adsorption.

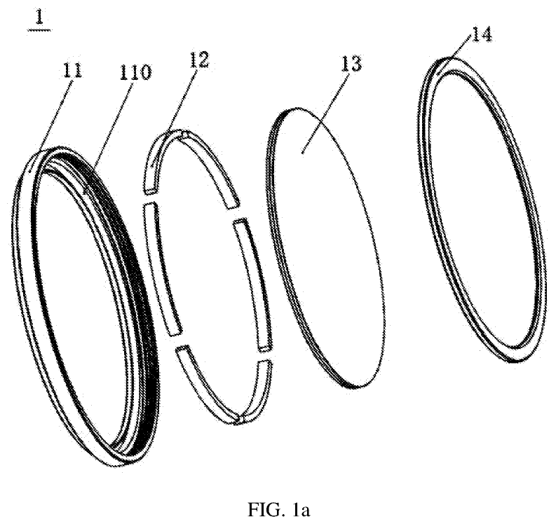

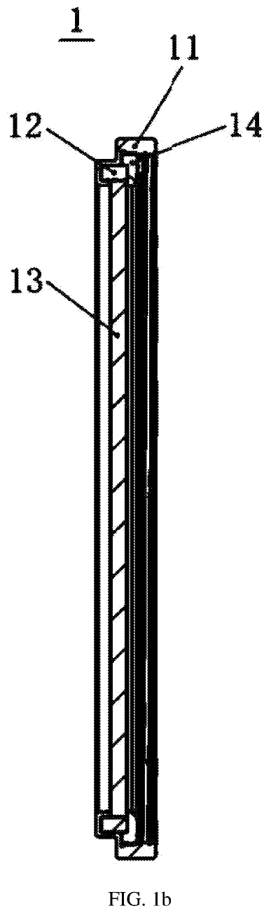

As shown in the FIG. 1a and FIG. 1B, the filter assembly 1 includes a lens ring 11, a magnet 12, a first filter lens 13 and a first clamping ring 14. Specifically, a first slot 110 for containing the magnet is provided on an edge of the lens ring 11, the first slot 110 is a slot structure adapted to a shape of the first magnet 12, and the first magnet 12 is mounted in the slot 110.

The first filter lens 13 is mounted in a through hole of the lens ring 11, and both of the first magnet 12 and the filter lens 13 are firmly pressed and fixed on the lens ring 11 through the first clamping ring 14, so as to avoid falling.

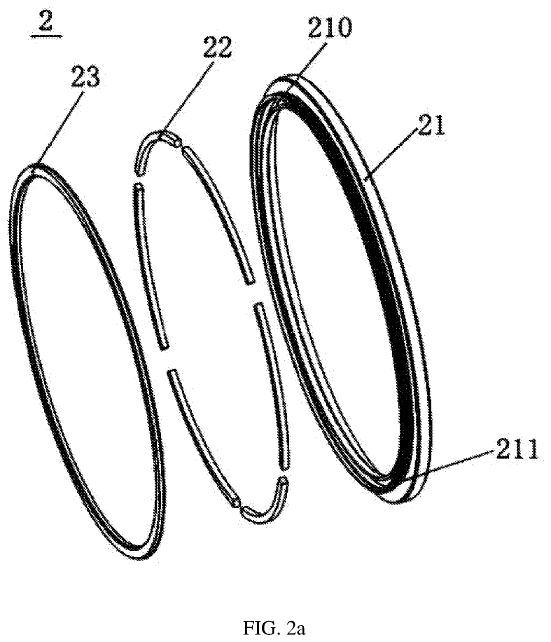

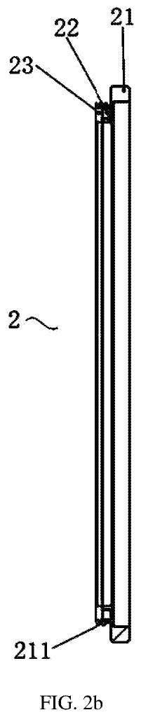

As shown in the FIG. 2a and FIG. 2b, the adapter ring 2 includes a fixing ring 21, a second magnet 22 and a second clamping ring 23. Specifically, a second slot 210 for containing the magnet is provided on the fixing ring 21, the second slot 210 is a slot structure adapted to a shape of the second magnet 22, the second magnet 22 is mounted in the slot 110.

The second magnet 22 is firmly pressed and fixed on the fixing ring 21 through the second clamping ring 23, so as to avoid falling. Besides, a side of the fixing ring 21 away from the filter assembly 1 is provided with a first external thread structure 211 configured to be screwed with the lens.

In some embodiments, the first magnet 12 and the second magnet 22 can be an annular magnetic stripe or a columnar magnetic block; correspondingly, the first slot 110 and the second slot 210 are annular slots or have a plurality of annularly distributed slot holes. When the first magnet 12 is the annular magnetic stripe, the first slot 110 is an annular slot; when the first magnet 12 is the columnar magnetic block, the first slot 110 has a plurality of annularly distributed slot holes provided on an edge of the lens ring 11; an adapt design of the second magnet 22 and the second slot 210 is same as a design of the first magnet 12 and the first slot 110.

In this embodiment, both the first magnet 12 and the second magnet 22 are an annular magnetic stripe consisting of multi curved magnetic stripes, and both the first slot and the second slot are annular slots consisting of multi curved slot holes.

In this embodiment, the first slot 110 corresponds to the second slot 210, and a bottom of the first slot 110 protrudes outside an end surface of the lens ring 11, and the bottom part of the first slot 110 is configured to go deep inside and beneath an end surface of the fixing ring 21 when assembling with the adapter ring 2, so the first magnet 12 in the first slot 110 and the second magnet 22 in the second slot 210 is correspondingly adsorbed to make the filter assembly 1 and the adapter ring 2 correspond to each other and fixed, so as to complete a stable assembly of the filter assembly 1 and the adapter ring 2.

In the nonferrous magnetic filter system, the adapter ring 2 is assembled with a camera lens through the external thread structure 211 of the fixing ring 21, while the filter assembly 1 is configured to be assembled on the adapter ring 2 from a side of the adapter ring 2 through a mutual adsorption of the first magnet 12 and the second magnet 22, so as to assemble needed filter lenses on the camera lens.

The lens ring 11, the first clamping ring 14, the fixing ring 21 and the second clamping ring 23 are all made of nonmagnetic metal or alloy material, so as to reduce the weight of the whole magnetic filter system and avoid the overload of the camera lens assembled with the magnetic filter system and avoid an oxidizing defect of the ferromagnetic material, thus the magnetic filter system can maintain beauty and be more durable.

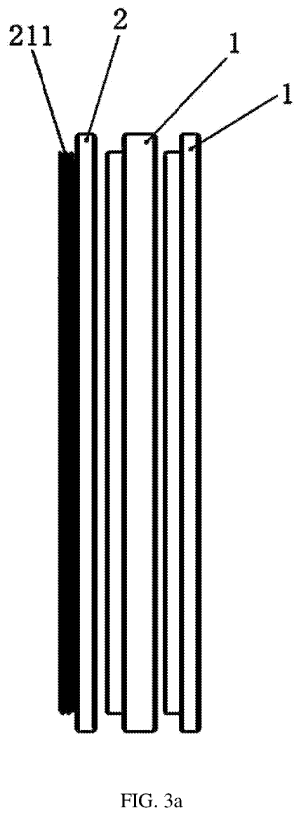

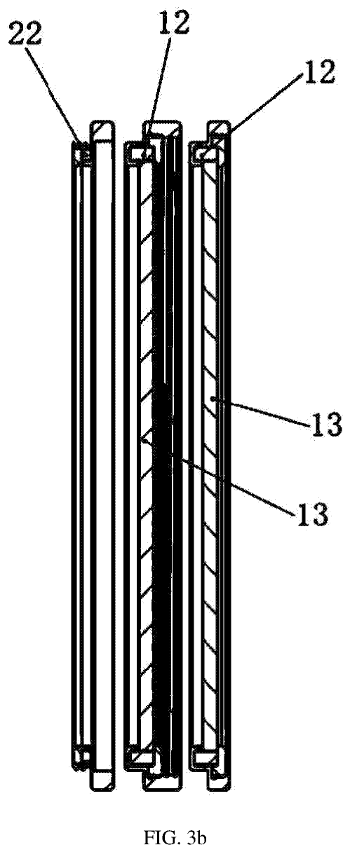

As shown in the FIG. 3a and the FIG. 3b, in the nonferrous magnetic filter system, the filter assembly 1 and the adapter ring 2 are assembled through the mutual adsorption of the first magnet 11 and the second magnet 22. In an embodiment, the number of the filter assembly 1 is at least two, and the at least two filter assemblies 1 are successively assembled through the mutual adsorption of the first magnets 12, thus a plurality of filter assemblies 1 are successively assembled according to an actual shooting purpose, and the filter lens can be pulled out to be replaced, thus meeting various kinds of shooting requirements.

In this embodiment, the number of the filter assembly 1 is two, and the first filter assembly 1 adjacent to the adapter ring 2 is assembled on the adapter ring 2 through the mutual adsorption of the first magnet 12 of the first filter assembly 1 and the second magnet 22 of the adapter ring 2, while the second filter assembly 1 is assembled on the first filter assembly 1 through the mutual adsorption of the first magnet 12 of the second filter assembly 1 and the first magnet 12 of the first filter assembly 1, thus the two assemblies 1 are assembled.

### Embodiment 2

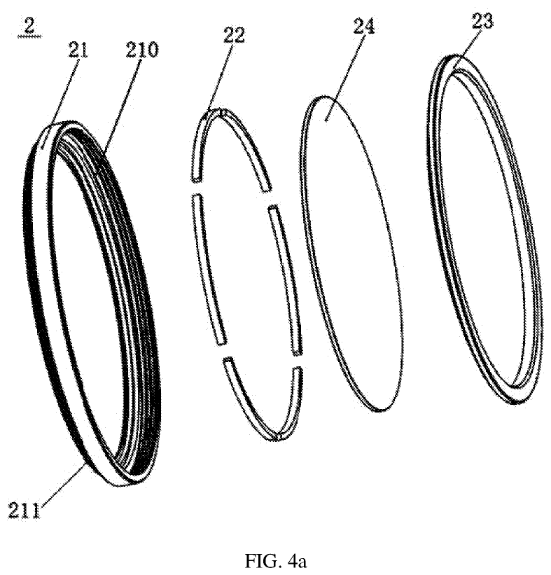

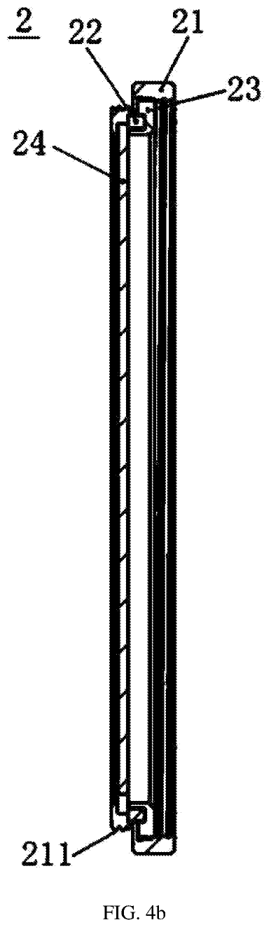

The nonferrous magnetic filter system of the present disclosure is same as the embodiment 1, as shown in FIG. 4a and FIG. 4b, a second filter lens 24 is mounted in a through hole of the adapter ring 2, and both the second magnet 22 and the second filter lens 24 are firmly pressed and fixed on the fixing ring 21 through the second clamping ring 23. The adapter ring 2 with a filter lens is configured to be assembled with the filter assembly 1, and the filter lens in the filter assembly 1 and the adapter ring 2 can be pulled out to be replaced, to meet various kinds of shooting requirements.

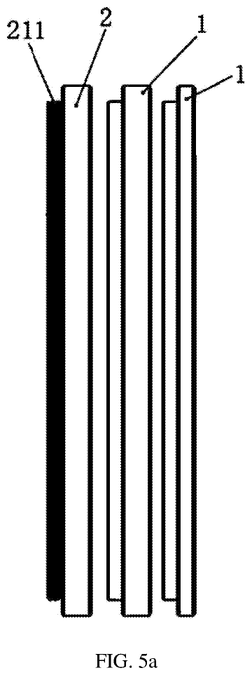

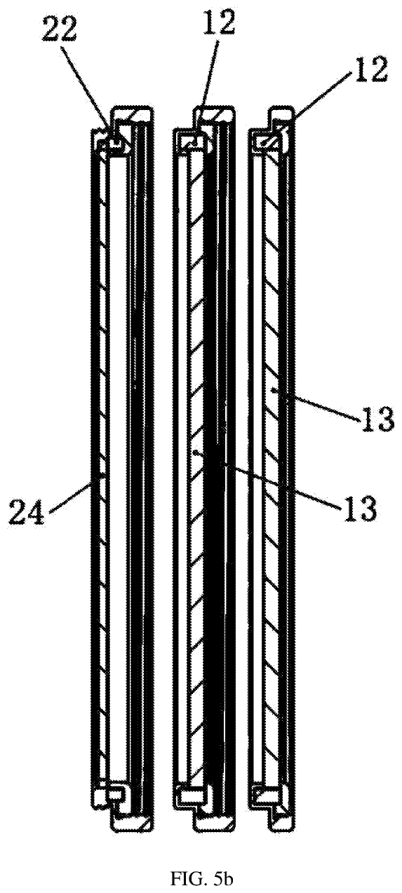

As shown in FIG. 5a and FIG. 5b, in the nonferrous magnetic filter system, the filter assembly 1 and the adapter ring 2 are assembled through a mutual adsorption of the first magnet 12 and the second magnet 22.

### Embodiment 3

The nonferrous magnetic filter system of the present disclosure is same as the embodiment 1 or embodiment 2, the nonferrous magnetic filter system further includes a lens cap 3. The lens cap 3 can be directly mounted on the front end of the filter assembly 1 or the adapter ring 2 through a magnetic adsorption without demounting the filter assembly 1 or the adapter ring 2 in front of a camera lens, so as to directly protect the filter assembly 1 or the adapter ring 2.

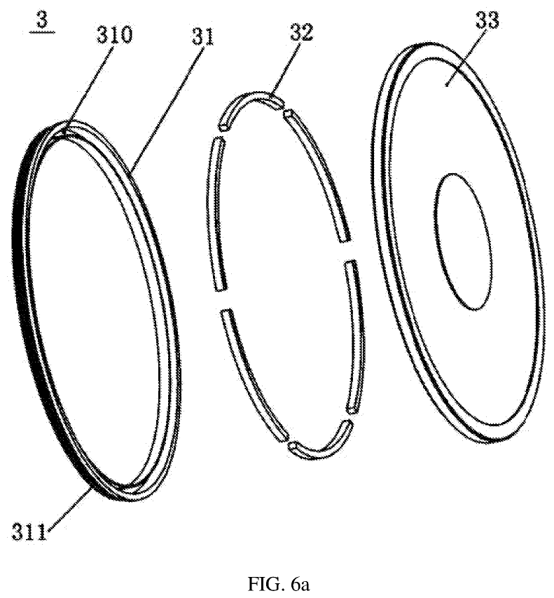

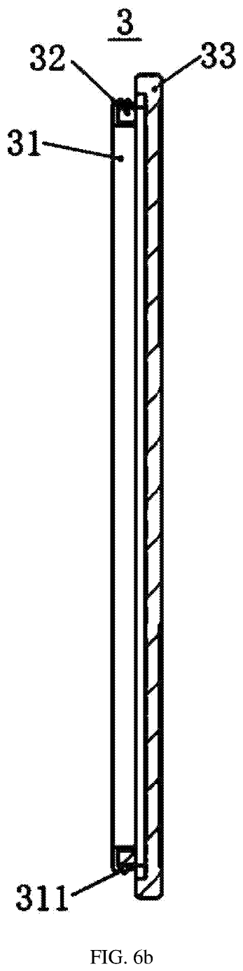

As shown in FIG. 6a and FIG. 6b, the lens cap 3 includes a fixing cover ring 31, a third magnet 32 and a cover plate 33. The fixing cover ring 31 is made of nonmagnetic metal or alloy material, thus can reduce the weight of the whole magnetic filter system.

An edge of the fixing cover ring 31 is provided with the third slot 310; the third magnet 32 is mounted in the third slot 310. In the embodiments, the third magnet 32 is an annular magnetic stripe or a columnar magnetic block; the third slot 310 is an annular slot or has a plurality of annularly distributed slot holes. In this embodiment, the third magnet 32 is an annular magnetic stripe consisting of multi curved magnetic stripes, and the third slot 310 is an annular slot consisting of multi curved slot holes. The cover plate 33 is mounted on a side of the fixing cover ring 31, and the third magnet 32 is firmly pressed and fixed on the fixing cover ring 31, so as to avoid falling.

The lens cap 3 is configured to be assembled on the filter assembly 1 from a side away from the adapter ring 2 through a mutual adsorption of the third magnet 32 and the first magnet 23; or the lens cap 3 is configured to be assembled on the adapter ring 2 from a side of the adapter ring 2 through a mutual adsorption of the third magnet 32 and the second magnet 22.

Specifically, a bottom of the third slot 310 protrudes outside an end surface of the fixing cover ring 31, the bottom part of the third slot 310 is configured to go deep inside and beneath an end surface of the lens ring 11 of the filter assembly 1 when the lens cap 3 is mounted in front of the filter assembly 1, or the bottom part of the third slot 310 is configured to go deep inside and beneath an end surface of the fixing ring 21 when the lens cap 3 is mounted in front of the adapter ring 2. Thus, when assembling the lens cap 3 with the filter assembly 1 or with the adapter ring 2, the third magnet 32 in the third slot 310 and the first magnet 12 in the first slot 110 are configured to correspond with each other and be adsorbed to stabilize the assembly of the lens cap 3 and the filter assembly 1, or the third magnet 32 in the third slot 310 and the second magnet 22 in the second slot 210 are configured to correspond with each other and be adsorbed to stabilize the assembly of the lens cap 3 and the adapter ring 2.

Besides, in an embodiment, the side of the fixing cover ring 31 away from the cover plate 33 is provided with a second external thread structure 311 for screwing with a lens. Therefore, after the filter assembly 1 or the adapter ring 2 is detached from the front of the lens, the lens cap 3 is configured to be attached into a camera lens through a thread engagement so as to directly protect the camera lens for a flexible usage.

The above embodiments are only preferred embodiments of the present disclosure, and only have further been described in detail on the technical solutions of the present disclosure, but the protection scope and the implementation manner of the present disclosure are not limited thereto, and any changes, combinations, deletions, substitutions, or modifications made under the spirit and principle of the present disclosure will be included in the protection scope of the present disclosure.

What is claimed is:

1. A nonferrous magnetic filter system, comprising:
a filter assembly comprising a lens ring, a first magnet, a first filter lens and a first clamping ring; and
an adapter ring comprising a fixing ring, a second magnet and a second clamping ring,
wherein:
a first slot for containing a magnet is provided on an edge of the lens ring;
the first magnet is mounted in the first slot;
the first filter lens is mounted in a through hole of the lens ring;
the first magnet and the filter lens are firmly pressed and fixed on the lens ring through the first clamping ring;
a second slot for containing the magnet is provided on an edge of the fixing ring;
the second magnet is mounted in the second slot;
the second magnet is firmly pressed and fixed on the fixing ring through the second clamping ring; and
the filter assembly is configured to be assembled on the adapter ring from a side of the adapter ring through a mutual adsorption of the first magnet and the second magnet.

2. The nonferrous magnetic filter system of claim 1, wherein:
a second filter lens is mounted in a through hole of the adapter ring; and
both the second magnet and the second filter lens are firmly pressed and fixed on the fixing ring through the second clamping ring.

3. The nonferrous magnetic filter system of claim 1, wherein a side of the fixing ring away from the filter assembly is provided with a first external thread structure screwed with a lens.

4. The nonferrous magnetic filter system of claim 1, wherein:
the nonferrous magnetic filter system comprises at least two filter assemblies; and
the at least two filter assemblies are adsorbed and successively assembled to each other through a mutual adsorption of the first magnets.

5. The nonferrous magnetic filter system of claim 1, wherein the lens ring, the first clamping ring, the fixing ring and the second clamping ring are all made of a nonmagnetic metal or an alloy material.

6. The nonferrous magnetic filter system of claim 1, wherein:
both the first magnet and the second magnet are annular magnetic stripes or columnar magnetic blocks; and
the first slot and the second slot are annular slots or have a plurality of annularly distributed slot holes.

7. The nonferrous magnetic filter system of claim 1, further comprising:
a lens cap comprising a fixing cover ring, a third magnet and a cover plate,
wherein:
an edge of the fixing cover ring is provided with a third slot for containing the magnet, the third magnet is mounted in the third slot, the cover plate is mounted on a side of the fixing cover ring;
the lens cap is configured to be assembled on the filter assembly from a side away from the adapter ring through a mutual adsorption of the third magnet and the first magnet; or
the lens cap is configured to be assembled on the adapter ring from a side of the adapter ring through a mutual adsorption of the third magnet and the second magnet.

8. The nonferrous magnetic filter system of claim 7, wherein a side of the fixing cover ring away from the cover plate is provided with a second external thread structure screwed with the lens.

9. The nonferrous magnetic filter system of claim 7, wherein the fixing cover ring is made of a nonmagnetic metal or an alloy material.

10. The nonferrous magnetic filter system of claim 7, wherein:
the third magnet is an annular magnet stripe or a columnar magnetic block; and
the third slot is an annular slot or has a plurality of annularly distributed slot holes.
